(19) United States
(12) Patent Application Publication
(10) Pub. No.: US 2007/0025417 A1
(43) Pub. Date: Feb. 1, 2007

(54) System and method for mitigating filter transients in an ultra wideband receiver

(75) Inventors: Deepak M. Joseph, Fairfax, VA (US); Timothy R. Miller, Arlington, VA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR INC.

(21) Appl. No.: 11/190,901

(22) Filed: Jul. 28, 2005

(51) Int. Cl. H04B 1/69

(52) U.S. Cl. 375/130

(57) ABSTRACT

A system (600) and method (500) are presented for mitigating a transient in processing a received signal (710) in a signal path associated with an Ultra Wideband (UWB) receiver. An impending processing event associated with processing the received signal is detected. A processing element (201, 202, 203, 204) capable of generating a transient when activated, is activated prior to the processing event such that the transient is mitigated or cleared when the processing event occurs and the received signal is processed. At least a portion of the processing element is normally deactivated so as to conserve power. The processing event includes one or more of: an acquisition processing event, a lock processing event, and a tracking processing event associated with the received signal in the signal path.

### FIELD OF THE INVENTION

The present invention relates generally to wireless communication systems, such as ultra wideband (UWB) systems. In particular, the present invention relates to a system and method in a receiver, including receivers located in mobile transceivers, centralized transceivers, related equipment, for mitigating the transient effects associated with the operation of filters during receiver processing events.

### BACKGROUND OF THE INVENTION

Ultra wideband (UWB) receivers face unique challenges in signal reception due to low signal levels, high signal frequencies, and the like associated with the UWB signal environment. In particular, given that, for reasons understood in the art, rake type receivers are widely used to process multipath components of a transmitted signal, one of the multipath components must be chosen as the component for receive processing and in order to select a finger, processing must be performed on each filter as various signal components are received. As is understood, rake receivers have processing “fingers” or separate signal paths which generate signal estimates and perform other signal recovery operations such as clock recovery. It is further understood that such operations and processing are generally performed on each of the fingers independently of each other. Still further, to take advantage of digital signal processing, many filter operations, particularly those associated with processing signal components associated with transmission protocols are conducted using filters configured within the signal processor. However, because many devices are sensitive to power demands and issues of cross talk and the like, certain filter components may be disabled when not in use either as hardware modules or cells or as software routines or the like. It will be appreciated that in application specific integrated circuits (ASICs), sections of the circuit can be dedicated to specific filter functions and those sections can be disabled and enabled as processing demands dictate.

Embedded in the received signal information are known data segments such as a preamble segment, a start of second preamble (SSP) segment, and the like. Further, when each finger successfully acquires the signal component, a LOCK processing event occurs. One of ordinary skill will recognize that a LOCK signal is typically generated when a threshold value, such as, for example, a signal to noise ratio or the like associated with a correlation product between the received signal and a local oscillator signal is achieved or crossed. It will be appreciated that generally, by the time the SSP segment is received, one of the fingers should be chosen for further processing, since information following the SSP will be actual payload data. Since, as noted above, the filters associated with processing the received signal in connection with certain processing events such as a LOCK processing event, tracking processing, or the like, are normally deactivated, the filters must be turned on or otherwise switched into the signal path to process the processing event.

However, when the filters are switched on, powered on, activated or the like, transients generated from the switching of the filters into the signal path occur for several time intervals before settling occurs and meaningful processing can be conducted. Since the signals in the UWB environment are relatively high speed signals, important information can be missed while waiting for the filters to stabilize and certain key processing events can go undetected or can be delayed leading to loss of signal lock, loss of tracking or the like which in turn can lead to undesirable consequences such as data errors, data loss, or the like. Further undesirable consequences could result depending on the importance of the underlying data application.

Further, since power conservation is a key issue, the time during which the processing filters are in the signal path should be as short as possible. Thus it would be desirable for a receiver to better process signals on receiver fingers while accounting for timing related factors such as the timing associated with obtaining LOCK and receipt of certain segments.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages in accordance with the present invention.

FIG. 1 is a diagram illustrating an Ultra Wideband (UWB) environment including a transmitter and receiver in accordance with various exemplary embodiments of the present invention;

FIG. 2 is a block diagram illustrating various blocks of a receiver in accordance with various exemplary embodiments of the present invention;

FIG. 3 is a diagram illustrating a receiver showing independent clock domains and a system clock domain of a receiver in accordance with various exemplary embodiments of the present invention;

FIG. 4 is a diagram illustrating exemplary UWB waveforms and signal measurement points in accordance with various exemplary embodiments of the present invention;

FIG. 5 is a flow chart illustrating procedures of a method in accordance with exemplary embodiments of the present invention;

FIG. 6 is a diagram illustrating a receiver apparatus in accordance with various exemplary embodiments of the present invention; and

FIG. 7 is a diagram illustrating activation of exemplary processing elements in accordance with various exemplary embodiments of the present invention.

### DETAILED DESCRIPTION OF PREFERRED EMBODIMENTS

UWB Signal Environment

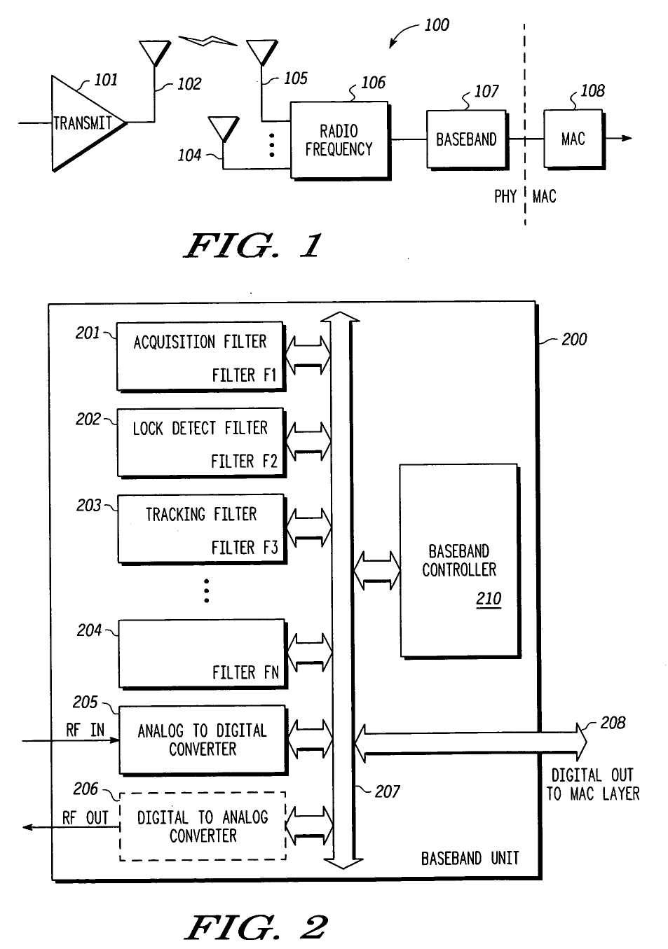

A UWB environment 100, for example, as shown in FIG. 1, typically includes a transmitter 101, with one or more transmit antennae 102, and a radio frequency (RF) section 106 having one or many antennae such as receive antenna 104 through receiver antenna 105. It will be appreciated that multiple antennae can be used to support transmit/receive diversity systems the use of which, as is understood by one of ordinary skill, is desirable in radio communication systems. As a signal is detected and processing begins, for example in the RF section 106, a baseband module 107 can be used for control and processing of raw signals and performing operations such as selecting receiver fingers and the like. As baseband module 107 extracts data from the received signal and payload information is obtained, such information can be passed along to the media access control (MAC) module 108 for further digital processing. It will also be appreciated in the art that processing downstream from the MAC module 108 can be considered as part of the physical layer (PHY) processing and upstream from and including the MAC module 108 can be considered part of the MAC layer processing.

In accordance with various exemplary embodiments, a UWB receiver can be provided with a baseband unit 200 as shown in block diagram form in FIG. 2. It will be appreciated that baseband unit 200 is shown with processing elements, such as digital filters or the like, each of which can be associated with a receiver finger. Although baseband module 200 occupies the same general position in the processing path as baseband unit 107, and may perform many of the same functions, additional features and processing elements are described in connection with the present invention. Such processing elements may be duplicated in silicon, for example in the case of an ASIC, or may be configured as a single processing circuit configured to process multiple inputs corresponding to multiple fingers, or some combination thereof. Stated differently, each of the fingers may have a dedicated processing cell associated therewith or may be input to a multi-channel processor in the case of an ASIC or the like. Alternatively, the fingers may be processed in a signal processor configured to handle the multiple fingers where a software or quasi-software implementation is used. By quasi-software implementation, it will be appreciated that a hardware interface such as an analog-to-digital converter can be coupled to a signal processor executing a software based routine or routines coupled thereto to perform filtering functions. It will be appreciated that even in the case of an ASIC, various degrees of software may be used in connection therewith without departing from the invention.

Accordingly, an incoming signal can be input to an analog-to-digital converter 205 and be converted to a series of samples, or a digital signal at or close to baseband frequencies. It will be appreciated that processing in accordance with various exemplary embodiments will generally take place in the digital domain by operation of baseband controller 210 and processing elements such as filters F1 201-FN 204. If the receiver also functions as a transmitter (i.e., it is actually a transceiver) any RF output can be converted from digital to analog by a digital-to-analog converter 206. It should be noted that filters F1 201-FN 204 can be configured as dedicated processing elements, special purpose digital filters, or the like in an exemplary ASIC. For example filter F1 201 can be configured as an acquisition filter designed to recognize and acquire signal energy from the total energy received on a channel. Filter F2 202 can be configured as a lock detect filter designed to recognize, for example, a preamble in the signal and, generally after iterations through an automatic gain control (AGC) stage (not shown) can, in connection with baseband controller 210, establish a LOCK condition with regard to the signal. The LOCK condition, as will be described in greater detail hereinafter, is declared when a segment of the signal such as the preamble is trained upon and a threshold level established with respect thereto. The threshold can be, for example, a signal to noise ratio associated with a correlation product between the incoming signal and a local oscillator signal as will be appreciated by one of ordinary skill in the art. It will be appreciated that filters F1 201-FN 204 along with the baseband controller 210, can be coupled using a bus 207 as will be appreciated. It will further be appreciated that to the extent control lines or analog signal lines commonly known and used in the art are present in baseband unit 200, these lines can be considered as part of bus 207. A digital connection 208 to the MAC layer can also be present in the form of an additional connection between the bus 207 and any higher level processors or the like responsible for MAC layer operation as will be appreciated by one of ordinary skill in the art.

Other purposes can be established for the exemplary filter elements. For example, filter F3 203 can be configured as a tracking filter for tracking signal parameters during reception and allow for gain adjustments or the like once a signal LOCK is achieved. It is important to note that, parameters associated with the filters F1 201-FN 204, such as acquisition related parameters, lock related parameters, tracking related parameters, and the like can be used in accordance with various exemplary embodiments as will be described. Also as noted, the filters F1-201-FN204 can be configured to be normally deactivated in order to conserve power. However, during activation of the filters, transients can occur which must be addressed. As will be appreciated, in accordance with various exemplary embodiments, the filter elements can be implemented in silicon and, as part of the signal path, can disturb the quiescent state of the signal path when switched in. Such disturbances might result from momentary impedance mismatches, transient effects attributable to the hybrid parameters of the switching element and arising from discontinuities associated with the switching processing event and the subsequent loading from the filter circuit.

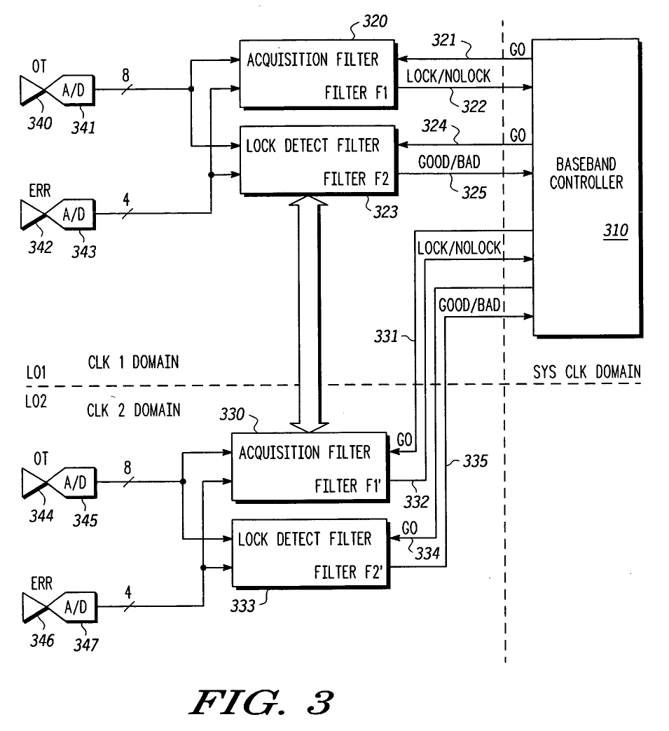

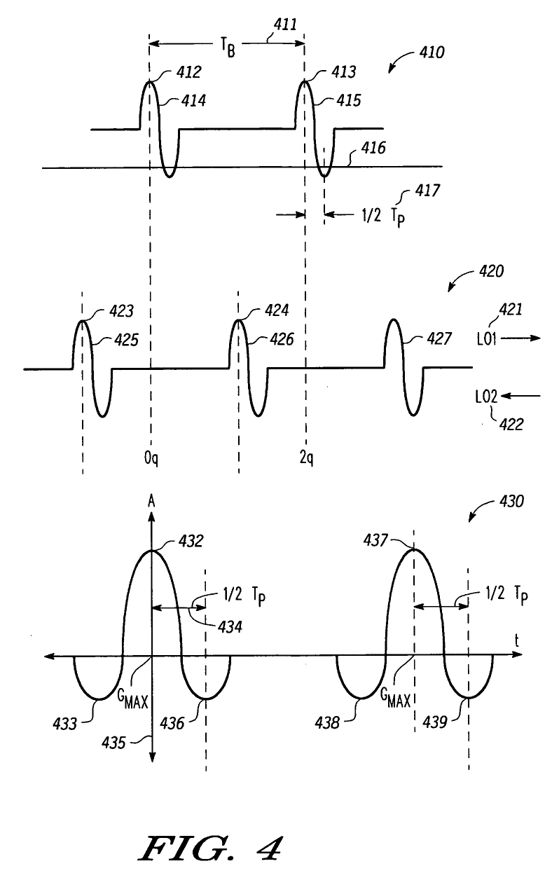

To better understand the operation of the present invention in connection with receiving UWB signals and mitigating filter transients associated with filter activation, a more detailed diagram of an exemplary receiver is shown in FIG. 3. A first clock domain CLK 1 DOMAIN and a second clock domain CLK 2 DOMAIN are shown with respective local oscillators LO1 and LO2. The first clock domain CLK 1 DOMAIN and the second clock domain CLK 2 DOMAIN are associated with the respective clocks extracted from the incoming multipath component of the received signal and are independent from each other, that is, each clock domain can be synchronous with the respective extracted clock and asynchronous, at least to a degree, with respect to the other clock domain. In addition, a system clock domain SYS CLK DOMAIN is associated with the receiver processing circuitry such as the baseband controller 310, and the like which is further independent from the first clock domain CLK 1 DOMAIN and the second clock domain CLK 2 DOMAIN. However, in extracting clock domain information, synchronization of processing can be accomplished and information regarding the average time for receipt of certain signal components can be collected and used to establish a statistic for a most likely receive time associated with a processing event such as the predicted time for receipt of an SSP segment or the like.

As shown in FIG. 3, when a signal is received, on-time (OT) and error (ERR) components are determined for each finger based on the incoming signal and a locally generated signal used by that finger (e.g., OT component 340 and ERR component 342 for the first finger, and OT component 344 and ERR component 346 associated with the second finger). The OT components 340 and 344 are received at analog-to-digital converters 341 and 345, while the ERR components 342 and 346 are received at analog-to-digital converters 343 and 347.

Analog-to-digital conversion is then conducted and the resulting digitized signals are processed in, for example, filters F1 320 and F2 323 for the first finger and filters F1′ 330 and F2′ 333 for the second finger. The digitized OT and ERR components can be processed in an acquisition filter F1 320 and a lock filter F2 323, and the digitized OT and ERR components can be processed in an acquisition filter F1′ 330 and a lock filter F2′ 333. Although not shown in FIG. 3, other filters could be used to process the incoming signal components, e.g., a tracking filter. Furthermore, additional fingers could be used, in which case more OT and ERR signal components could be generated.

In the disclosed embodiment the acquisition filters F1 320 and F1′ 330 receive a digitized OT component, a digitized ERR component, and a GO signal from the baseband controller 310. The acquisition filters F1 320 and F1′ 330 each generate a LOCK/NOLOCK signal that is provided to the baseband controller 310. Respective GO signals indicate that the respective acquisition filter F1 320 or F1′ 330 should be active; respective LOCK/NOLOCK signals indicate whether a respective acquisition filter F1 320 or F1′ 330 has successfully achieved a signal lock.

In the disclosed embodiment the lock filters F2 323 and F2′ 333 receive a digitized OT component, a digitized ERR component, and a GO signal from the baseband controller 310. The lock filters F2 323 and F2′ 333 each generate a GOOD/BAD signal that is provided to the baseband controller 310. Respective GO signals indicate that the respective lock filter F2 323 or F2′ 333 should be active; respective GOOD/BAD signals indicate whether a respective lock filter F2 323 or F2′ 333 has determined that acquisition has been maintained (GOOD) or lost (BAD).

It will be appreciated that a baseband controller 310 is used to control the operation of the acquisition and lock filters by providing the GO control outputs 321, 324, 331, 334, and to process inputs from the filters such as the LOCK/NOLOCK signals 322 and 332, and the GOOD/BAD signals 325 and 335.

As previously noted the clock domains can be synchronized under control of, for example, the baseband controller 310 or other synchronization circuits. The clock domains can also be configured to share information such as signal to noise levels or other parameter levels or filter states such as LOCK or NOLOCK indications or the like therebetween.

To better appreciate the nature of the transmitted signal, FIG. 4 shows several diagrams of a received signal 410, a local oscillator (LO) signal 420 and a composite signal 430. The received signal 410 is a biphase modulated signal transmitted across an air interface in accordance with a typical UWB radio environment. The received signal 410 can represent a multi-bit code chip, or encoded information transmitted in accordance with a bit time 411 and each signal portion 414 and 415 have local maxima 412 and 413 relative to a reference level 416 and with a pulse period 417. While FIG. 4 discloses an embodiment using a single biphase pulse as a modulated signal, other embodiments could use other sorts of wavelets to carry data. For example a set number of repetitions of a sine wave could be used to carry data. In this case, each repetition of three sine waves could be modulated to indicate the data value being sent. Strings of these data values could be put together to form code words, each code word indicating a single data bit value.

The LO signal 420 is mixed with the received signal 410 and shifted in one direction according to a LO1 direction 421 and shifted in another direction according to a LO2 direction 422. It will be appreciated that the LO signal 420 can contain oscillator pulses 425, 426, and 427 with local maxima 423 and 424. The shifting of the LO signal 420 and mixing based on the LO1 direction 421 and the LO2 direction 422 with the received signal 410, inter alia, provides for downconversion of the received signal 410 to baseband frequencies and facilitates maximizing the threshold or gain level of the composite signal 430 which can represent a correlation between the received signal 410 and the LO signal 420. It can be seen that the composite signal 430 can consist of downconverted pulses having gain maxima 432 and 437, gain minima at 433, 436, 438, and 439 with reference to an amplitude axis 435 and a pulse period 434. The LO signal 420 is preferably modulated in accordance with the modulation of the received signal, thus when the LO signal 420 and the received signal 410 are closely correlated, the gain maxima 432 and 437 will be achieved.

While FIG. 4 discloses all of the signal portions 414, 415, 425, 426, and 427 being in the same orientation (i.e., non-inverted), it should be understood that since they are bi-phase modulated, some signal portions will be inverted to indicate an alternate value. Thus, a non-inverted signal portion will indicate a first value and an inverted signal portion will indicate a second value.

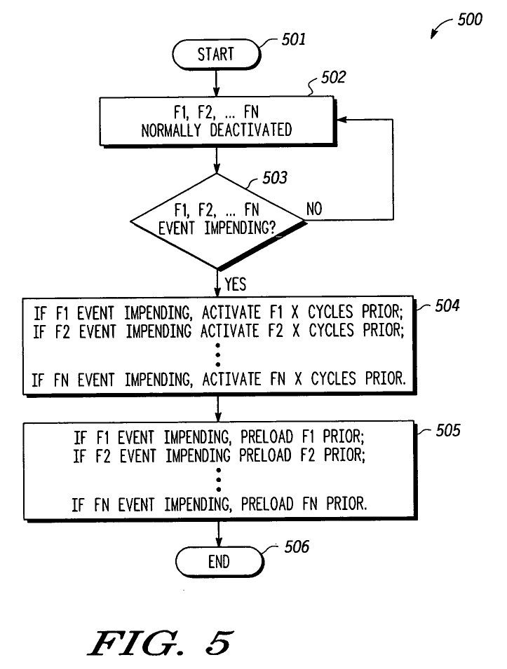

FIG. 5 is a flow chart illustrating procedures of a method in accordance with exemplary embodiments of the present invention. As shown in FIG. 5, a procedure 500 can be performed so as to mitigate transients associated with processing signals received on a signal path. After start at 501, processing can begin by, for example, baseband controller 210/310 ensuring that filters F1, F2, . . . FN are deactivated in accordance with normal operation at 502. It will be appreciated as noted above, that the processing can be broken into filter processing to be conducted in filter elements as described herein above, and control processing which can be conducted on a general purpose processor, a dedicated processor, a signal processor, a logic array, or the like, or a combination of these elements operating under the control of, for example, an operating system and various application programs, routines or the like. It will also be appreciated that certain additional circuits or circuit elements may be present as are known in the art such as mixers, bandpass filters, analog-to-digital converters, or the like.

Before transients can be mitigated, it is necessary to determine whether an processing event associated with received signal processing, referred to herein as a processing event is impending at 503. It will be appreciated that in synchronized time division multiple access (TDMA) type systems, it is generally easier to know a priori when processing events will occur and accordingly, filters can be activated a predetermined time or number of samples prior to the event and output can be held back until the filter is settled, that is, until the transients have passed. By holding back, it will be understood that the output of the filter can be discarded, ignored, or otherwise not used. Typically, 20 to 30 samples are sufficient to clear the filter of transients. It should also be noted that in setting the predetermined time, power conservation should be kept in mind. Since the processing elements associated with the processing events are normally deactivated to conserve power, the predetermined time should be kept as short as possible so as to allow for the transient to pass and the filter output to settle, while still conserving power. When statistical analysis is used, as will be described in greater detail hereinafter, to determine when an impending processing event is expected to occur, it will be appreciated that the predetermined time can be kept to the shortest possible time

In non-synchronous communications, it is more difficult to know when processing events may occur. Several methods can be used to predict when processing events will occur such as maintaining history of typical relative times associated with processing related processing events. For example, it can be determined when the receipt of an SSP segment is likely by maintaining a history of elapsed times, measured for example in clock cycles, sample cycles, or the like from a reference processing event such as the beginning time for preamble processing. A statistic can be developed using the accumulated times to establish a trend or a likelihood associated with the processing event time.

If no processing event is impending processing can loop between 503 and 502, or can otherwise be suspending pending the impending occurrence of a processing event. If a processing event is determined to be impending, either through direct a priori knowledge or through a statistic, then the filter associated with the processing event can be activated prior to the occurrence of the processing event. The processing can be held back for a predetermined number of cycles as described above. For example if a preamble is received, then a priori knowledge or a statistic can be used to determine when the occurrence of an SSP is likely at which time the appropriate filter can be activated at a time x cycles, time intervals, or the like prior to the anticipated processing event time at 504. It will be appreciated that by merely activating the filter a sufficient amount of time prior to the even time, the filter can be cleared of any transients caused by activation. However, due to power considerations, the pre-activation time should be as short as practical.

In accordance with other exemplary embodiments, in addition to the above noted procedure of activating the filters in advance, or instead of the above noted procedure, the filters can be preloaded with contents, such as filter initial states, prior to the processing event in an attempt to expedite the clearing of transients, to minimize the severity of transients, or to prevent transients from occurring at all. Accordingly, when a processing event associated with one of the filters is determined to be impending, the initial states of the filter can be preloaded prior to the processing event at 505. It will be appreciated that the filter initial states can be pre-stored in a register or memory associated with the processor or ASIC as is well known, or could be derived during operation such as by preloading the filter with the most recent filter states from the last filter operation, or through the execution of a calculation designed to approximate the initial states required during activation or the like.

The initial filter states can be a zero value, a previous initialization value, a value close to but below a predicted initial value for the filter, or the like, such that, for example, computational complexity and processing time is minimized. After the filter is initialized with initial state values or otherwise cleared, the processing can begin. The exemplary procedure can take place during normal receive processing for processing events such as acquisition processing, lock processing, and the like and can be repeated on a packet-by-packet basis. Further the detection of impending processing events can be conducted for each anticipated processing event associated with a received packet. The exemplary procedure can end at 506 although it will be appreciated that the procedure can continue looping for each processing event in need of processing or execution can pass to another procedure or the like as noted above.

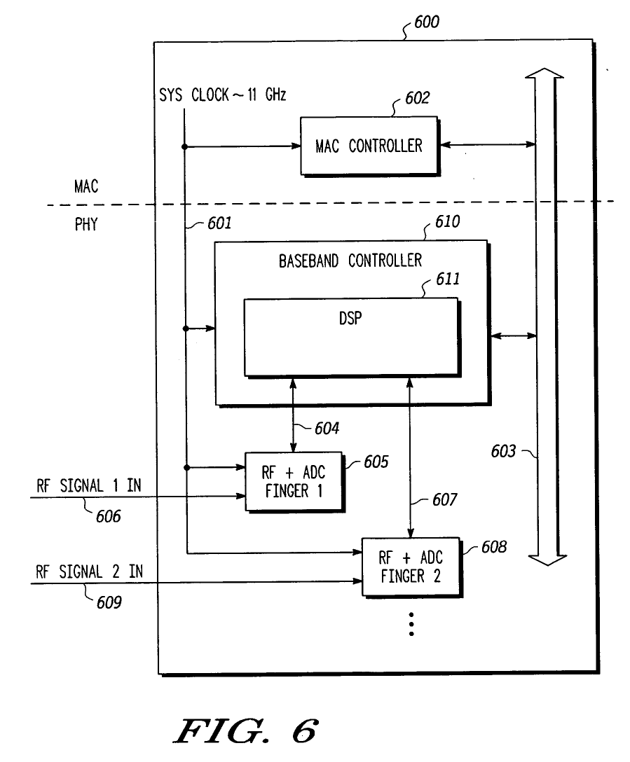

The exemplary procedure, as described above, can be implemented as noted using a processor or the like and an operating system and suitable software. It will be appreciated that an exemplary apparatus capable of mitigating filter transients in accordance with various exemplary embodiments of the present invention is shown in FIG. 6. A receiver 600, or a corresponding receiver module in an exemplary receiver or transceiver can be equipped with a media access control (MAC) controller 602 located in a MAC portion of the receiver 601 and can be used for controlling access to and retrieval of information from the lower layers of the device such as the physical (PHY) layer in accordance with MAC oriented protocol parameters. The PHY layer can contain components configured to perform activities associated with transferring information across a physical medium such as an air interface, an optical interface, a wired interface or the like in accordance with PHY protocol parameters. The PHY layer contains a baseband controller 610 having a processor such as a digital signal processor (DSP) 611. The MAC layer and PHY layer components can be coupled using a bus 603 and the components in the exemplary receiver 600 can be operated from a system clock 601 or derivative thereof. In order to process incoming received signals such as a RF SIGNAL 1 IN 606 and a RF SIGNAL 2 IN 609, the exemplary receiver 600 can be equipped with a finger 1 605 and a finger 2 608 containing for example an RF block and Analog-to-digital Converter block and the like as will be appreciated. The finger 1 605 and the finger 2 608 are coupled to the DSP 611 by links 604 and 607 respectively which can be a special high speed data connection for the sampled signal data or the like provided the speed is high enough to support UWB signal rates. The exemplary procedures can be implemented on each finger in order to mitigate transients as filters associated with fingers are activated.

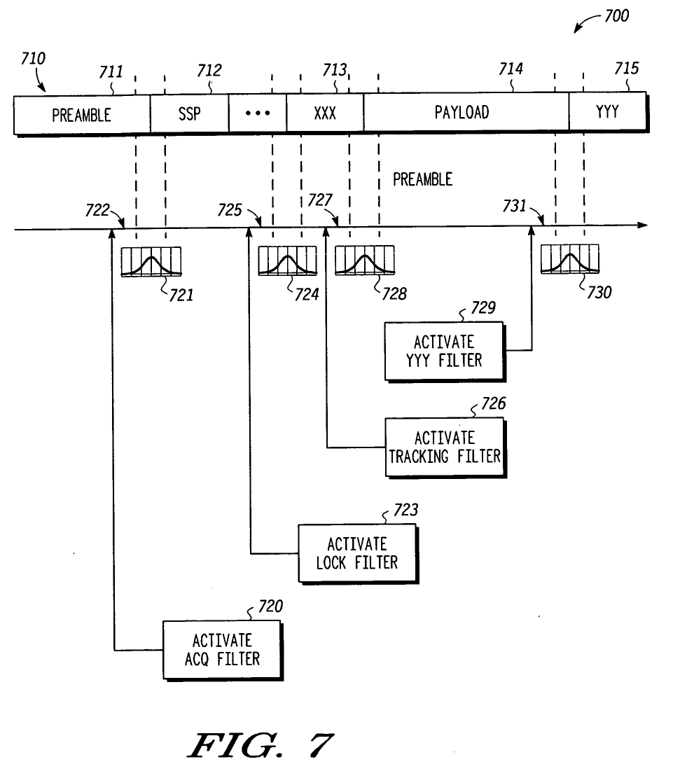

To better appreciate the scenarios capable of being addressed using the inventive concepts discussed and described herein, a diagram of exemplary scenario 700 associated with a received signal is shown in FIG. 7. An exemplary signal 710 shows different signal segments for reception, acquisition, and lock of signals. The exemplary signal 710, which can be a signal received on a finger of an exemplary receiver, has a preamble 711 an SSP 712 which can mark the beginning of, for example, a signal lock condition, a XXX segment 713 which can be another SSP segment, an AGC segment, or any other significant segment for which a processing element or filter can be activated. The signal 710 can include a payload 714 and a YYY segment 715, which can be a postamble, CRC, or the like.

As received signal 710 is processed, and, in particular the preamble 711, it can be determined when to activate, for example, an acquisition filter 720 by either a priori knowledge of when the processing event can be expected as described herein above or by a statistic 721, which can be a trend, a statistical distribution, or the like. The acquisition filter 720 can be activated a predetermined number of cycles, time intervals, or the like such that the interval 722 is sufficient to clear the filter of transients prior to the processing event, such as the reception of the SSP 712. After acquisition has been performed, the acquisition filter 720 can be deactivated and it can be determined when to activate the lock filter 723 by either a priori knowledge or by a statistic 724. In some embodiments, the previous filter can remain activated until the activation of the subsequent filter. The lock filter 723 can be activated such that the interval 725 is sufficient to clear the filter of transients prior to the processing event, such as the reception of the XXX segment 713. After lock has been performed, the lock filter 723 can be deactivated and it can be determined when to activate the tracking filter 726 by either apriori knowledge or by a statistic 728. The tracking filter 726 can be activated such that the interval 727 is sufficient to clear the filter of transients prior to the processing event, such as the reception of the payload segment 714. Tracking can continue through the reception of the payload until it can be determined when to activate the YYY filter 729 by either apriori knowledge or by a statistic 730. The YYY filter 729 can be activated such that the interval 731 is sufficient to clear the filter of transients.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method for mitigating a transient in processing a received signal in a signal path associated with an ultra wideband (UWB) receiver, the method comprising:
determining that a processing event associated with the processing the received signal is impending; and
activating a processing element corresponding to the processing event a predetermined time prior to an occurrence of the processing event, the processing element associated with the processing the processing event, the processing element capable of generating the transient when activated, the predetermined time set to mitigate the transient after the processing event occurs,
wherein:
the processing element is deactivated immediately after the processing event is processed; and
the predetermined time is set as short as possible so as to mitigate the transient and conserve power.

2. A method as recited in claim 1, wherein at least a portion of the processing element is normally deactivated so as to conserve power.

3. A method as recited in claim 1, wherein the processing event includes one or more of: an acquisition processing event associated with the received signal in the signal path, a lock processing event associated with the received signal in the signal path, and a tracking processing event associated with the received signal in the signal path.

4. A method as recited in claim 1, wherein the processing element includes at least a portion of a signal processing component associated with the processing event.

5. A method as recited in claim 4, wherein:
the processing event and the processing element include one or more of: an acquisition processing event associated with the received signal in an acquisition filter, a lock processing event associated with the received signal in a lock detection filter, and a tracking processing event associated with the received signal in a tracking filter; and
the acquisition filter, the lock detection filter, and the tracking filter are normally deactivated so as to conserve power.

6. A method as recited in claim 1, wherein the processing includes digital signal processing of the received signal in one or more of a plurality of digital filters associated with the processing event.

7. A method as recited in claim 1, wherein the processing includes digital signal processing of the received signal in one or more of a plurality of digital filters and wherein the transient includes a transient associated with activating the one or more of the plurality of digital filters.

8. A method as recited in claim 1, wherein the activating the processing the received signal prior to the processing event includes activating a digital filter associated with the processing event at a predetermined number of clock cycles prior to the processing event.

9. A method as recited in claim 8, wherein the predetermined number of clock cycles includes a range of from about 5 to about 60 clock cycles.

10. A method as recited in claim 1, wherein the activating the processing the received signal prior to the processing event includes activating a digital filter associated with the processing event prior to the processing event.

11. A method as recited in claim 10, wherein the activating the digital filter associated with the processing event prior to the processing event includes preloading the digital filter associated with the processing event with initial filter states prior to the processing event to mitigate the transient.

12. A circuit for mitigating a transient in processing a received signal in a signal path associated with an ultra wideband (UWB) receiver, the circuit comprising:
a digital signal path associated with the received signal and the signal path;
a processor coupled to the digital signal path, the processor having one or more normally deactivated processing elements associated with one or more processing events, the one or more normally deactivated processing elements capable of generating the transient when activated, the processor configured to:
determine that one of the one or more processing events is impending, the one of the one or more processing events corresponding to one of the one or more normally deactivated processing elements; and
activate the one of the one or more normally deactivated processing elements a predetermined time prior to the impending one of the one or more processing events such that the transient is mitigated when the processing event occurs, the one of the one or more normally deactivated processing elements deactivated as soon as the impending one of the one or more processing events is processed.

13. A circuit as recited in claim 12, wherein:
the processor includes a digital signal processing component and the one of the one or more normally deactivated processing elements includes a digital filter associated with the impending one of the one or more processing events; and
the digital signal processing component, in activating the one of the one or more normally deactivated processing elements, is further configured to activate the digital filter associated with the impending one of the one or more processing events prior to when the one of the impending one or more processing events occurs.

14. A circuit as recited in claim 12, wherein the impending one of the one or more processing events includes one of: an acquisition processing event associated with the received signal in the digital signal path, a lock processing event associated with the received signal in the digital signal path, and a tracking processing event associated with the received signal in the digital signal path.

15. A circuit as recited in claim 12, wherein the processor determines in activating the one of the one or more normally deactivated processing elements prior to when the impending one of the one or more processing events occurs is further configured to activate the one of the one or more normally deactivated processing elements prior to a predicted start time associated with the impending one of the one or more processing events, the predicted start time based on a statistic associated with a previous start time of the one of the one or more processing events.

16. A circuit as recited in claim 15, wherein the processor, in activating the one of the one or more normally deactivated processing elements prior to when the impending one of the one or more processing events occurs is further configured to activate the one of the one or more normally deactivated processing elements a predetermined number of clock cycles prior to the processing event, the predetermined number of clock cycles including a range of from about 5 to about 60 clock cycles.

17. A circuit as recited in claim 12,
wherein the processor determines that one of the one or more processing events is impending by detecting a preceding event, and
wherein the processor activates the one of the one or more normally deactivated processing elements a set time after the detection of the preceding event.

18. A circuit as recited in claim 12, wherein the activating the digital filter associated with the impending one of the one or more processing events prior to when the impending one of the one or more processing events occurs includes preloading the digital filter with initial filter states prior to the processing event to mitigate the transient.

19. A system for mitigating a transient in processing a received signal in a signal path associated with an ultra wideband (UWB) device, the system operating according to a protocol, the system comprising:
a physical layer (PHY) portion associated with the protocol; and
a media access control (MAC) portion associated with the protocol, the MAC portion coupled to the PHY portion,
wherein:
the PHY portion includes a baseband processor configured to determine from the MAC portion that a processing event associated with processing the received signal is impending; and
the PHY portion further includes a digital signal processing component having configured to activate a normally deactivated processing element corresponding to the impending processing event, the normally deactivated processing element capable of causing the transient when activated, the normally deactivated processing element activated a predetermined time prior to the processing event such that the transient is mitigated when the processing event occurs, the predetermined time set as short as possible so as to mitigate the transient and conserve power.

20. A system as recited in claim 19, wherein the digital signal processor, in activating the normally deactivated processing element the predetermined time prior to the processing event, is further configured to activate the normally deactivated processing element a predetermined number of clock cycles prior to the processing event.

21. A system as recited in claim 19, wherein the normally deactivated processing element includes one or more of: an acquisition filter associated with an acquisition processing event of the received signal in the digital signal path, a lock filter associated with a signal lock processing event of the received signal in the digital signal path, and a tracking filter associated with a tracking processing event of the received signal in the digital signal path.
